(19) United States
(12) Patent Application Publication
(10) Pub. No.: US 2015/0266549 A1
(43) Pub. Date: Sep. 24, 2015

(54) Oscillating Piston-Type Wave Power Generation Method and System

(71) Applicant: Yanming Qu, Weihai (CN)

(72) Inventor: Yanming Qu, Weihai (CN)

(21) Appl. No.: 14/434,960

(22) PCT Filed: Oct. 11, 2012
(86) PCT No.: PCT/CN2012/082749

§ 371 Date: Apr. 10, 2015

(51) Int. Cl. B63B 21/50; F03B 13/18; B63B 35/44

(52) U.S. Cl. CPC B63B 21/50; B63B 35/44; F03B 13/1845; B63B 2035/4466

(57) ABSTRACT

The present invention is related to a method and system for wave power generation. When a floating body rises with the wave, a hydraulic cylinder is being pulled to drive a hydraulic motor; the hydraulic motor will in turn drive the generation of power. When a stroke action of the hydraulic cylinder is completed, signals will be transmitted to a drum to release the rope, at which time the hydraulic cylinder will be reset. When the reset is completed, the distance between the floating body and the anchor base increases, the hydraulic cylinder is pulled again, thus repeating the above process. When the floating body drops along with the wave, the hydraulic cylinder is reset at first and then the drum retracts the rope. This system can automatically reset the hydraulic cylinder and do work multiple times during the process of one rising wave.

### CROSS REFERENCE OF RELATED APPLICATION

This is a national phase national application of an international patent application number PCT/CN2012/082749 with a filing date of Oct. 11, 2012. The contents of the specification, including any intervening amendments thereto, are incorporated herein by reference.

### BACKGROUND OF THE PRESENT INVENTION

1. Field of Invention

The present invention is related to a method and system for wave power generation.

2. Description of Related Arts

Ocean wave energy is an inexhaustible and renewable energy resource. How to use this abundant energy resource for human services is always a big project in study, and the wave-power generation is a major subject in this project.

Because the ocean is affected by the complex and varying natural factors, the changing size and form of the tide and the waves make it a great difficulty for people to use the energy of the ocean wave to generate stably. Over 100 years scientists from different countries have put forward more than 300 kinds of assumptions and have invented a wide variety of wave energy generation apparatuses. The apparatuses can be divided by principle as follows: oscillating water column, pendulum, oscillating body, floating-body angle type, contraction channel type, etc. According to the different foundation platform the apparatuses can be divided into: shore based type, shallow pile foundation type, floating type and submersible type. The Japanese Hamming Hyperion Power Generation ship is floating oscillating-water-column type; the Israeli company SDE's apparatus is shore based pendulum; the English Pelamis is floating-body angle type; the apparatus from Norway is contraction channel type; Denmark's is staking rocker; American Powerbuoy's is an oscillating body with floating foundation platform, etc.

Currently the mainly problems of various wave power generation systems are as follows: high cost, poor survivability, poor ability to adapt to different waves, poor corrosion resistance, low utilization rate of the wave height, low conversion efficiency, unstable output power, high failure rate, high maintenance costs and so on.

Pelamis, the recently emerged generation technology, its design philosophy is focused on the survivability but ignoring the efficiency. It just takes advantage of changes in the angle between the surface waves to extract energy. The steeper the wave surface, the greater the energy extraction. If we observe the waveform carefully, we will find a great wave height does not necessarily go with a steep wave surface for the wave lengths are longer. Also in small waves, the strikes from the wave that each section receives are similar. Therefore, the power moment cannot be formed, the output is almost zero, and the economic benefit is limited.

There is another wave power generation system whose mode is floating-body heaving hydraulic cylinder. The wave height is often sizes up to more than 10 meters. If the hydraulic cylinder is done quite long, it is a severe waste and a high cost, and a short one is not long enough to make a good use of a big wave.

### SUMMARY OF THE PRESENT INVENTION

The present invention aims to provide an oscillating piston type wave power generation method and system. It can automatically adapt to most forms of waves and has strong ability to resist wind and waves. More importantly, it can automatically reset the hydraulic cylinder and do work multiple times during the process of one rising wave.

### Technical scheme

A wave-energy collect and power generation system comprises an energy collect section, an energy conversion section, rope or webbing, an anchor base, and particularly in the case of this invention, a control section.

The energy collect section is in the form of a floating body or a swing plate. The energy conversion section comprises a hydraulic system and a generator.

The control section comprises stroke-ending sensors, a signal transmission device or electric-power transmission wires and auxiliary power, and a rope-control device.

The circulation route of the hydraulic system comprises a hydraulic cylinder, an outlet check valve, a hydraulic motor, a low-pressure accumulator and an entry check valve. The generator is driven by the hydraulic motor.

The hydraulic cylinder is connected to the floating body. One end of a rope or webbing is tied to a piston rod of hydraulic cylinder, and the other end leads to the rope-control device which is fixed on the anchor base, or connected by a rope with the anchor base. The rope-control device can also be fixed to the floating body. One end of the rope from the rope-control device goes through a fixed pulley of the anchor base and is tied to the piston rod.

The hydraulic cylinder can be reset without the low pressure accumulator. Instead, it can be reset with a reset spring. In that case, the circulation route of the hydraulic system goes through the hydraulic cylinder, the outlet check valve, the high-pressure accumulator, the hydraulic motor, an oil tank, the entry check valve and then back to the hydraulic cylinder.

The hydraulic system can also be a pneumatic transmission system, in which the pneumatic components will function instead of the hydraulic components.

Also, the rotary generator can be driven without a hydraulic or a pneumatic transmission, but with a rack and pinion transmission mechanism. The rack is connected with the rope, and a support of the pinion is in a box which is connected with the floating body, so the generator can be driven by the pinion. Or a linear generator can be used instead, i.e. the linear generator body and a mover are connected with the floating body and the rope respectively. The reset of the linear motion components or mover is realized by a return spring.

The hydraulic cylinder, or the pneumatic cylinder, or the rack, or the linear generator is equipped with stroke-ending sensors, which can drive the rope-control device by the signal transmission device or the electric power transmission wire.

There are three kinds of rope-control devices, one of which is a micro-controller unit mode comprised of a locking mechanism, a motion directional sensor, a micro-controller unit module and a rope retraction mechanism.

The locking mechanism is a pair of components which rub against or occlude each other. Occluding means that when the two components come into contact, one occupies the location which the other is about to move to or one component is of a convex shape while the other is of a concave shape. When the convex one enters into the concave one, both cannot move away from each other. The locking mechanism may also be a positive displacement pump and a solenoid switching valve which are connected in series and form a closed loop conduit. For the pair of components which rub against or occlude each other, one of them can be fixed on a support of the rope-control device and the other is a moving part. If it is linear motion, the moving component moves together with the rope from the energy conversion section for they are connected directly. If it is rotary motion, the moving component of the locking mechanism is connected with the rope via a linear-rotary motion conversion mechanism.

The linear-rotary motion conversion mechanism is formed by wrapping a rope around a drum, or by passing a chain around a chain wheel or a rack and pinion transmission mechanism, whose rotary component is connected with other mechanisms by a shaft coupling in order to transmit.

The rope retraction mechanism can be a motor, a spring, a gas spring, a counterweight or a submerged buoy, which is connected with the moving component of the locking mechanism, generating an opposite force against the pulling rope force generated via the energy conversion section. If it is linear motion, the moving component of the locking mechanism can be connected directly with extension springs or compression springs or the gas spring or the counterweight or the linear motor or the rope linked with the submerged buoy, bypassing the fixed pulley which is fixed on a bracket of the rope-control device. If the moving component of the locking mechanism is in the form of rotational movement, it can be shaft-coupled with the rotary motor or the spiral spring of the rope retraction mechanism, or the moving component of the locking mechanism can be connected via the linear-rotary motion conversion mechanism with the linear motor or the extension spring or the compression spring or the gas spring or a string which is connected with the counterweight or the submerged buoy. The other end of the extension spring or the expression spring or the gas spring or the spiral spring is fixed on the support of the rope-control device.

The motion directional sensor monitors the direction of the movement of the moving component of the locking mechanism. The micro-controller unit module controls the parts in the locking mechanism and realizes their separation and actuation by receiving signals from stroke-ending sensors via a signal transmission device and also signals from the motion directional sensor.

The second type of rope-control device is unidirectional transmission mechanism.

The unidirectional transmission mechanism can be a ratchet/ratchet bar or an overrunning clutch.

The ratchet bar is connected with the rope retraction mechanism and the rope from the energy conversion mechanism. A corresponding pawl controlled by the stroke-ending sensor is fixed on the support.

For the mode of a ratchet, the ratchet is connected to the rope retraction mechanism via a shaft coupling or a linear-rotary conversion mechanism. The ratchet is also connected to the rope from the energy conversion section via the linear-rotary conversion mechanism, and its corresponding pawl is fixed on the support and controlled by the stroke-ending sensor.

As for the overrunning clutch, its driving wheel is shaft coupled with the rope refraction mechanism or connected with the rope retraction mechanism via the linear-rotary conversion mechanism. The overrunning clutch is connected with the rope from the energy conversion section via the linear-rotary conversion mechanism. And the driven wheel of the overrunning clutch is connected with the support via the locking mechanism. The two parts of the locking mechanism are controlled by the stroke-ending sensor which causes the actuation or separation.

When the pawl is skidding off, the driving wheel of the overrunning clutch or the ratchet/ratchet bar moves in the direction of the rope-retraction.

The third way is via a check valve control. More specifically, the structure is as follows: The linear motion component part of the linear-rotary motion conversion mechanism is connected with the rope retraction mechanism and the rope from the energy conversion section while the rotary motion component part of the linear-rotation motion conversion mechanism is shaft coupled with the positive displacement pump. The switch valve and the check valve's parallel connection forms a branch which is connected to the positive displacement pump via a series connection to complete a closed-loop hydraulic conduit, with the switch valve being controlled by the stroke-ending sensor.

Control is implemented through regulating high-voltage with weak current through the micro-controller unit, or using a stroke-ending sensor to exercise switching control over electric circuits of the power source to realize the connection or disconnection of electric current which causes actuation or separation of the electromagnet or the control over the rotation of the motor. And the amplification can be chosen to be done by way of hydraulic or gear transmission in order to drive separation or joining of the pair of component parts in the locking mechanism. Alternatively, one can exercise control over the electromagnetic valve in the pneumatic or hydraulic conduits at the pressure source—through pressure control on the piston which is connected to the moving component part of the locking mechanism, generating action to separate or join the pair of component parts.

The locking mechanism can take the form of an electromagnetic clutch, or a brake disc and a brake pad, or a brake bar and a brake pad, or an electric bolt lock.

The signal transmission device can be either the signal transduction wire or fiber or a sonic wave transmission device.

The rope-control device comprises a solenoid directional valve, a high-pressure oil circuit, a low-pressure oil circuit, a tank of the braking system and a brake pad. The solenoid directional valve controls the switching of connection between the rodless cavity, rod cavity, high-pressure oil circuit and low-pressure oil circuit. It is controlled by the micro-controller unit module or by way of connection/disconnection of the wire via the stroke-ending sensor.

An alternative form of rope-control device comprises a drum, a locking mechanism, direction sensors, a rope refraction mechanism, a micro-controller unit module, and auxiliary power source. The structure can be specifically described in the following words: The drum is shaft coupled with the rope retraction mechanism which is a PWM motor, or a spiral spring with one end shaft coupled with the drum and the other end attached to the drum support, such that the torque produced is in the direction of rope refraction. Alternatively, it can be a rope which is attached to and coiled around a smaller drum shaft coupled to the drum, with the other end attached to a counterweight or submerged buoy such that the torque produced is in the direction of rope retraction.

The drum's locking mechanism comprises a brake disc which is shaft coupled with the drum and a brake pad. Alternatively, it can be an electromagnetic clutch with one end shaft coupled with the drum and the other end fixed to the drum support. Either of the above can indirectly control the drum through variable gear transmission or chain transmission.

The drum and rope can also be respectively replaced by a chain wheel and chain, with the rope-retraction mechanism replaced by a chain attached to a counterweight.

The micro-controller unit module receives signals from the stroke-ending sensor on the hydraulic cylinder through the wire as well as signals from the motion directional sensors of the drum, in order to control the locking mechanism.

An alternative structural form of rope-control device is as such: rope-control device including a drum, a rope refraction mechanism, and a ratchet or an overrunning clutch. The drum is shaft coupled with the rope retraction mechanism and the ratchet.

The pawl which corresponds to the ratchet is on the drum support, and is being controlled through an electric wire by the stroke-ending sensor on the hydraulic cylinder. The direction of free rotation of the ratchet is also that of the rope-retraction.

Another alternative structural form of rope-control device comprises the rope refraction mechanism, drum, overrunning clutch and electromagnetic clutch. In this case, each side of the overrunning clutch is shaft coupled with the drum and electromagnetic clutch, with the latter being controlled by the stroke-ending sensor at the hydraulic cylinder. The other end of the electromagnetic cutch is attached to the support. When the electromagnetic clutch is closed, i.e. the overrunning clutch's driven wheel is secured, the direction of the overrunning clutch's action wheel is also that of the rope-retraction.

The main parts of the generator and hydraulic system are in the chamber of the floating body. One end of a corrugated pipe is attached to the end of the piston rod of the hydraulic cylinder; the other end of the corrugated pipe is attached to the body of the hydraulic cylinder and sealed to form a cavity. This cavity is also connected to outlet and inlet tubes; the outlet tube is connected to the oil tank inside the floating body chamber via the outlet check valve. In the case of an open-type oil tank, the inlet tube is connected to the floating body cavity via the inlet check valve; in the case of a close-type oil tank, the inlet tube is connected to the oil tank via the inlet check valve. The tube's opening must be higher than the oil's surface.

Both the hydraulic system and generator are inside the floating body chamber. The hydraulic cylinder can be connected from the outside of its base to the base of the floating body via a joint through the center hole of a universal joint, or suspended bellow the top of the floating body with a rope from its top. The piston rod of the hydraulic cylinder extends from the bottom of the floating body through an opening; the bottom surface of the hydraulic cylinder is linked up with the opening via a concentric corrugated surface. A vertical seal-air pipe can be installed bellow the opening through which the piston rod of the hydraulic cylinder extends from the bottom of the floating body.

The stroke-ending sensor for the hydraulic cylinder is a magnetic induction proximity switch. Alternatively, it can be a sensor switch (sensitive to pressure and tension) at the end of the piston rod. The switch is connected to a pulling line, with one end of the pulling line attached to the bottom surface of the hydraulic cylinder. An electric connection is established when the switch is pulled. Conversely, the electric connection is broken when the switch is subject to pressure.

The stroke-ending sensor can be either the press sensor inducting to the top within the hydraulic cylinder or the press sensor inducting to the bottom at the bottom of the hydraulic cylinder.

A fairlead is fixed at the bottom of a bracket, which is fixed at the lower end of the floating body. The rope tied to the piston rod of the hydraulic cylinder passes through the fairlead and then is guided to the drum. The fairlead comprises two pairs of pulleys placed perpendicularly to each other, with the pulleys in each pair close to each other and in parallel.

This is a power-generation method by way of wave energy collection. One end of the rope is attached to the piston rod of the hydraulic cylinder, which is connected to a floating body or a swinging board. The other end of the rope, together with an additional section, is connected to a rope-control device. Thus, when the floating body rises with the wave, the rope between it and the rope-control device is in a locking state. The hydraulic cylinder is being pulled as the distance between the floating body and the anchor base increases. As the latter is being pulled, it will release high-pressure hydraulic oil to drive the hydraulic motor; the hydraulic motor will in turn drive the generation of power. When the stroke action of the hydraulic cylinder is completed, it will transmit a signal to the rope-control device to release a section of the rope, at which time the hydraulic cylinder will be rapidly reset by virtue of the reset force. When the reset is completed, the stroke-ending sensor of the hydraulic cylinder will transmit a signal to the rope-control device for the latter to cease releasing the rope. In this manner, the length of the rope between the hydraulic cylinder and rope-control device is once again locked in. As the distance between the floating body and the anchor base increases, the hydraulic cylinder is pulled again, thus repeating the above process. When the floating body drops along with the wave, the hydraulic cylinder is reset as a result of the reset force. This distance between it and the rope-control device shortens, thus causing the rope to relax, at which point the rope-control device begins to retract the rope with minimal force. When the floating body reaches the wave's trough, the rope-control device will cease retraction of the rope. The length of the rope between the floating body and the rope-control device is therefore fixed, and the process repeats itself again as the wave drops.

Double cylinder alternate acting method may be used. To be specific, the floating body is provided with two hydraulic cylinders and their respective rope-control devices. However, the signals of both stroke-ending sensors of the hydraulic cylinders are transmitted to one the micro-controller unit module. For the rope-control device with the motion directional sensor, the signals of the motion directional sensors of both rope-control devices are sent to the same micro-controller unit module;

As the floating body rises, the rope-control device of a hydraulic cylinder is being locked and the hydraulic cylinder is being pulled, whereas the rope-control device of the other hydraulic cylinder is in an unlock state—it is in a state complete reset and not working. When the floating body rises to a certain level and the stroke action of the hydraulic cylinder, which is with a rope being locked by length, is about to end, the stroke-ending sensor of the hydraulic cylinder will transmit a signal to the micro-controller unit module. At this point, the micro-controller unit module switches the working state of both rope-control devices, i.e. the rope-control device which is originally locked is unlocked to release the rope whereas the device which is originally unlocked is locked in order to lock in the length of its rope. In this way, the hydraulic cylinder which has originally completed its stroke will be reset, and the other hydraulic cylinder which is in complete reset and non-working state will begin to work as the length of its rope is being locked. The action will repeatedly switch between both hydraulic cylinders upon the transmission of the stroke-ending signal.

For a system that contains ratchets, the locking mechanisms of the two rope-control devices will always maintain a state whereby one device is locked while the other is being unlocked when the floating body drops. The rope-control device of the hydraulic cylinder in an unlock state will immediately retract the rope when the floating body drops, while the other hydraulic cylinder which is in a locked state and hence is working will be reset first, at which point its rope retraction mechanism will retract the rope with minimal force.

In the case of a system which contains a motion directional sensor instead of a ratchet, the rope-control device which is in an unlock state will immediately retract the rope when the floating body drops. When the rope-control device is in a locked state, its corresponding hydraulic cylinder will be reset first. As soon as the micro-controller unit module receives simultaneous complete reset signals from both hydraulic cylinders and the direction sensor's signal transmits a rope-retraction state, it will set the locking mechanisms for both rope-control devices in unlocking status in order for the rope-control devices to retract the rope with minimal force. As soon as the motion directional sensor releases a rope-release signal, the micro-controller unit will immediately secure the locking mechanism of one of the rope-control devices.

In this structure, the hydraulic cylinder can be replaced by a pneumatic cylinder or a linear generator or a rack and pinion driving generator mechanism.

The connection between the floating body and the hydraulic cylinder can either be hinge/solid joint or rope linking.

Several units of floating bodies and hydraulic cylinders can work simultaneously. The floating bodies are connected either by a locking ring or a candan universal joint. The hydraulic cylinders share a set of hydraulic conduit, hydraulic motor, generator, replenish pump and oil tank.

The circulation route of the hydraulic system can be formed by the hydraulic cylinder, outlet check valve, the high-pressure accumulator, hydraulic motor, the low-pressure accumulator and entry check valve. The pressure generated by the low-pressure accumulator is greater than the ambient pressure of the cylinder body. In the case of reset, the tension on the piston generated by differential pressure is greater than the rope refraction tension from the rope-control device. A relief valve is connected in parallel on both ends of the hydraulic motor; the replenish pump pumps oil from the oil tank and connects the pipeline at the low-pressure accumulator by the check valve.

In case that the rope retraction mechanism is a submerged buoy, the rope connecting the submerged buoy and the drum bypasses a spacing pulley to keep a certain distance between the submerged buoy and the drum.

If the rope-control device is fixed on the anchor base, rather than being connected via hinge joint or ropes, the rope extended from the piston rod of the hydraulic cylinder should first pass through the fairlead and then be guided to the rope-control device.

The generator may be coupled with a flywheel with great rotational inertia to increase the rotational inertia and improve generation stability.

The wire is shaped as a spiral spring with flexibility.

### Advantages of the Invention

1) Strong resistance to wind and waves

With the rope-control device, the stroke of the floating body will be no longer limited to the length of the hydraulic cylinder, thus enabling it to do work under greater waves.

2) High utilization of wave height

In the process of one rising wave, the hydraulic cylinder can do work for multiple times to effectively utilize the wave height.

3) Long service life

As the rope releasing of the drum requires quite small force, the friction acting on the rope is greatly reduced, the service life of the rope is thus extended.

### BRIEF DESCRIPTION OF THE DRAWINGS

FIG. 1: Flow chart of oscillating piston wave power generation (an micro-controller unit and an motion directional sensor)

FIG. 2: Flow chart of oscillating piston wave power generation (an electronic control ratchet)

FIG. 3: Reciprocal diagram of operating state of oscillating piston wave power generation signal—hydraulic cylinder—drum (a micro-controller unit and a direction sensor)

FIG. 4: Reciprocal diagram of operating state of oscillating piston wave generation wire—hydraulic cylinder—drum (electronic control ratchet)

FIG. 5: Structural diagram of oscillating piston wave power generation (the hydraulic cylinder is reset via a low-pressure accumulator and connected to the floating body via a hinge joint, a sensor switch sensitive to tension and compression, spiral spring for the retraction of the rope, and the drum is connected to the anchor base via a chain)

FIG. 6: Structural diagram of oscillating piston wave power generation (The hydraulic cylinder is reset by a spring and connected to the floating body via a solid joint, two sensors, the fairlead, submerged buoy for rope retraction, the drum is connected to the anchor base via a fixed joint)

FIG. 7: Perspective view and sectional view of upper part of oscillating piston wave power generation

FIG. 8: Structural diagram of the counterweight method of rope retraction of the drum

FIG. 9: Structural diagram of a rope-control device including a spiral spring, drum, overrunning clutch, and electromagnetic clutch (webbing)

FIG. 10: Structural diagram of rope-control device (a chain, a chain wheel, a brake disc, a micro-controller unit and a motion directional sensor)

FIG. 11: Structural diagram of rope-control device (a chain, a spiral spring, a chain wheel and an electronic control ratchet)

FIG. 12: Structural diagram of check valve controlled hydraulic rope-control device (spiral spring+drum+hydraulic pump+check valve+controlled switching valve)

FIG. 13: Structural diagram of the locking mechanism with positive displacement pump and rope-control device with overrunning clutch

FIG. 14: Structural diagram and the operation schematic of a double cylinder system with a single floating body

FIG. 15: Schematic of the control of brake pad by the micro-controller unit via solenoid directional valve

FIG. 16: Structural diagram of a fairlead

FIG. 17: Structural diagram of floating body and the rope-control device fixed on the floating body

FIG. 18: Structural diagram of double fixed pulleys on an anchor base

FIG. 19: Structural diagram of other three types of rope-control devices (a friction bar of the brake and the counterweight, an electric bolt lock and a counterweight, a ratchet bar and a counterweight)

FIG. 20: Structural diagram of a linear generator and stroke-ending sensors

FIG. 21: Structural diagram of a rack pinion and stroke-ending sensors

1 floating body

2 hydraulic cylinder

3 piston rod

4 Piston

5 rodless cavity

6 corrugated pipe

7 sensor inducting to the bottom

8 sensor inducting to the top

9 pulling line

10 the sensor switch (sensitive to pressure and tension)

11 low-pressure accumulator

12 high-pressure accumulator

13 hydraulic motor

14 generator

15 replenish pump

16 oil tank

17 entry check valve

18 outlet check valve

19 fairlead of the floating body

20 Wire

21 fairlead of the rope-control device

22 anchor base

23 pull rod

24 fixed pulley

25 submerged buoy for the rope retraction

27 pawl

28 electronic control pawl

29 chain

30 universal joint

31 rope

32 the counterweight

33 suspension support

34 drum

35 ratchet

36 webbing

37 spiral spring

38 electromagnetic clutch

39 driving wheel of the overrunning clutch

44 pulley of the fairlead

49 fixed support

51 check valve

52 inlet tube

53 rotating joint

54 reset spring

56 electromagnet

57 cavity of a corrugated pipe

58 outlet tube

59 driven wheel of the overrunning clutch

60 bottom of the piston rod

64 switching valve

65 chain wheel

66 brake disc

67 brake pad

68 motion directional sensor

69 tank of the brake system

70 micro-controller unit module

71 chain transmission 72 relief valve

73 concentric corrugated surface

74 candan universal joint with a hole in the centre

75 seal-air pipe

76 bracket

77 rack

78 short rope

79 friction bar of the brake

80 electric bolt lock

81 ratchet bar

82 mover

83 pinion

84 solenoid directional valve

85 high-pressure oil circuit

86 low-pressure oil circuit

### DETAILED DESCRIPTION OF THE PREFERRED EMBODIMENT

Aim: This invention aims to solve the problem of the operation of hydraulic cylinder with limited length under greater wave heights. Method: One end of the rope is attached to the piston rod of the hydraulic cylinder, which is connected to a floating body or a swinging board. The other end of the rope, together with an additional section, is connected to a rope-control device. Thus, when the floating body rises with the wave, the rope between it and the rope-control device is in a locking state. The hydraulic cylinder is being pulled as the distance between the floating body and the anchor base increases. As the latter is being pulled, it will release high-pressure hydraulic oil to drive the hydraulic motor; the hydraulic motor will in turn drive the generation of power. When the stroke action of the hydraulic cylinder is completed, it will transmit a signal to the rope-control device to release a section of the rope, at which time the hydraulic cylinder will be rapidly reset by virtue of the reset force. When the reset is completed, the stroke-ending sensor of the hydraulic cylinder will transmit a signal to the rope-control device for the latter to cease releasing the rope. In this manner, the length of the rope between the hydraulic cylinder and rope-control device is once again locked in. As the distance between the floating body and the anchor base increases, the hydraulic cylinder is pulled again, thus repeating the above process. When the floating body drops along with the wave, the hydraulic cylinder is reset as a result of the reset force. This distance between it and the rope-control device shortens, thus causing the rope to relax, at which point the rope-control device begins to retract the rope with minimal force. When the floating body reaches the wave's trough, the rope-control device will cease retraction of the rope. The length of the rope between the floating body and the rope-control device is therefore fixed, and the process repeats itself again as the wave drops.

As will be described below, the wave-energy collect generation system comprises energy collect section, energy conversion section, rope or webbing, anchor base, and particularly in the case of this invention, the control section.

The energy collect section is in the form of a floating body or a swing plate. The energy conversion section comprises a hydraulic system and a generator.

The control section comprises stroke-ending sensors, a signal transmission device or electric-power transmission wires and auxiliary power, and a rope-control device.

The circulation route of the hydraulic system comprises a hydraulic cylinder, an outlet check valve, a hydraulic motor, a low-pressure accumulator and an entry check valve. The generator is driven by the hydraulic motor.

The hydraulic cylinder is connected to the floating body. One end of a rope or webbing is tied to a piston rod of hydraulic cylinder, and the other end leads to the rope-control device which is fixed on the anchor base, or connected by a rope with the anchor base. The rope-control device can also be fixed to the floating body. One end of the rope from the rope-control device goes through a fixed pulley of the anchor base and is tied to the piston rod.

The hydraulic cylinder can be reset without the low pressure accumulator.

Instead, it can be reset with a reset spring. In that case, the circulation route of the hydraulic system goes through the hydraulic cylinder, the outlet check valve, the high-pressure accumulator, the hydraulic motor, an oil tank, the entry check valve and then back to the hydraulic cylinder.

The hydraulic system can also be a pneumatic transmission system, in which the pneumatic components will function instead of the hydraulic components.

Also, the rotary generator can be driven without a hydraulic or a pneumatic transmission, but with a rack and pinion transmission mechanism. The rack is connected with the rope, and a support of the pinion is in a box which is connected with the floating body, so the generator can be driven by the pinion. Or a linear generator can be used instead, i.e. the linear generator body and a mover are connected with the floating body and the rope respectively. The reset of the linear motion components or mover is realized by a return spring.

The hydraulic cylinder, or the pneumatic cylinder, or the rack, or the linear generator is equipped with stroke-ending sensors, which can drive the rope-control device by the signal transmission device or the electric power transmission wire.

There are three kinds of rope-control devices, one of which is a micro-controller unit mode comprised of a locking mechanism, a motion directional sensor, a micro-controller unit module and a rope retraction mechanism.

The locking mechanism is a pair of components which rub against or occlude each other. Occluding means that when the two components come into contact, one occupies the location which the other is about to move to or one component is of a convex shape while the other is of a concave shape. When the convex one enters into the concave one, both cannot move away from each other. The locking mechanism may also be a positive displacement pump and a solenoid switching valve which are connected in series and form a closed loop conduit. For the pair of components which rub against or occlude each other, one of them can be fixed on a support of the rope-control device and the other is a moving part. If it is linear motion, the moving component moves together with the rope from the energy conversion section for they are connected directly. If it is rotary motion, the moving component of the locking mechanism is connected with the rope via a linear-rotary motion conversion mechanism.

The linear-rotary motion conversion mechanism is formed by wrapping a rope around a drum, or by passing a chain around a chain wheel or a rack and pinion transmission mechanism, whose rotary component is connected with other mechanisms by a shaft coupling in order to transmit.

The rope retraction mechanism can be a motor, a spring, a gas spring, a counterweight or a submerged buoy, which is connected with the moving component of the locking mechanism, generating an opposite force against the pulling rope force generated via the energy conversion section. If it is linear motion, the moving component of the locking mechanism can be connected directly with extension springs or compression springs or the gas spring or the counterweight or the linear motor or the rope linked with the submerged buoy, bypassing the fixed pulley which is fixed on a bracket of the rope-control device. If the moving component of the locking mechanism is in the form of rotational movement, it can be shaft-coupled with the rotary motor or the spiral spring of the rope retraction mechanism, or the moving component of the locking mechanism can be connected via the linear-rotary motion conversion mechanism with the linear motor or the extension spring or the compression spring or the gas spring or a string which is connected with the counterweight or the submerged buoy. The other end of the extension spring or the expression spring or the gas spring or the spiral spring is fixed on the support of the rope-control device.

The motion directional sensor monitors the direction of the movement of the moving component of the locking mechanism. The micro-controller unit module controls the parts in the locking mechanism and realizes their separation and actuation by receiving signals from stroke-ending sensors via a signal transmission device and also signals from the motion directional sensor.

The second type of rope-control device is unidirectional transmission mechanism.

The unidirectional transmission mechanism can be a ratchet/ratchet bar or an overrunning clutch.

The ratchet bar is connected with the rope retraction mechanism and the rope from the energy conversion mechanism. A corresponding pawl controlled by the stroke-ending sensor is fixed on the support.

For the mode of a ratchet, the ratchet is connected to the rope retraction mechanism via a shaft coupling or a linear-rotary conversion mechanism. The ratchet is also connected to the rope from the energy conversion section via the linear-rotary conversion mechanism, and its corresponding pawl is fixed on the support and controlled by the stroke-ending sensor.

As for the overrunning clutch, its driving wheel is shaft coupled with the rope refraction mechanism or connected with the rope retraction mechanism via the linear-rotary conversion mechanism. The overrunning clutch is connected with the rope from the energy conversion section via the linear-rotary conversion mechanism. And the driven wheel of the overrunning clutch is connected with the support via the locking mechanism. The two parts of the locking mechanism are controlled by the stroke-ending sensor which causes the actuation or separation.

When the pawl is skidding off, the driving wheel of the overrunning clutch or the ratchet/ratchet bar moves in the direction of the rope-retraction.

The third way is via a check valve control. More specifically, the structure is as follows: The linear motion component part of the linear-rotary motion conversion mechanism is connected with the rope retraction mechanism and the rope from the energy conversion section while the rotary motion component part of the linear-rotation motion conversion mechanism is shaft coupled with the positive displacement pump. The switch valve and the check valve's parallel connection forms a branch which is connected to the positive displacement pump via a series connection to complete a closed-loop hydraulic conduit, with the switch valve being controlled by the stroke-ending sensor.

Control is implemented through regulating high-voltage with weak current through the micro-controller unit, or using a stroke-ending sensor to exercise switching control over electric circuits of the power source to realize the connection or disconnection of electric current which causes actuation or separation of the electromagnet or the control over the rotation of the motor. And the amplification can be chosen to be done by way of hydraulic or gear transmission in order to drive separation or joining of the pair of component parts in the locking mechanism. Alternatively, one can exercise control over the electromagnetic valve in the pneumatic or hydraulic conduits at the pressure source—through pressure control on the piston which is connected to the moving component part of the locking mechanism, generating action to separate or join the pair of component parts.

The locking mechanism can take the form of an electromagnetic clutch, or a brake disc and a brake pad, or a brake bar and a brake pad, or an electric bolt lock.

The signal transmission device can be either the signal transduction wire or fiber or a sonic wave transmission device.

The rope-control device comprises a solenoid directional valve, a high-pressure oil circuit, a low-pressure oil circuit, a tank of the braking system and a brake pad. The solenoid directional valve controls the switching of connection between the rodless cavity, rod cavity, high-pressure oil circuit and low-pressure oil circuit. It is controlled by the micro-controller unit module or by way of connection/disconnection of the wire via the stroke-ending sensor.

An alternative form of rope-control device comprises a drum, a locking mechanism, direction sensors, a rope refraction mechanism, a micro-controller unit module, and auxiliary power source. The structure can be specifically described in the following words: The drum is shaft coupled with the rope retraction mechanism which is a PWM motor, or a spiral spring with one end shaft coupled with the drum and the other end attached to the drum support, such that the torque produced is in the direction of rope refraction. Alternatively, it can be a rope which is attached to and coiled around a smaller drum shaft coupled to the drum, with the other end attached to a counterweight or submerged buoy such that the torque produced is in the direction of rope retraction.

The drum's locking mechanism comprises a brake disc which is shaft coupled with the drum and a brake pad. Alternatively, it can be an electromagnetic clutch with one end shaft coupled with the drum and the other end fixed to the drum support. Either of the above can indirectly control the drum through variable gear transmission or chain transmission.

The drum and rope can also be respectively replaced by a chain wheel and chain, with the rope-retraction mechanism replaced by a chain attached to a counterweight.

The micro-controller unit module receives signals from the stroke-ending sensor on the hydraulic cylinder through the wire as well as signals from the motion directional sensors of the drum, in order to control the locking mechanism.

An alternative structural form of rope-control device is as such: rope-control device including a drum, a rope refraction mechanism, and a ratchet or an overrunning clutch. The drum is shaft coupled with the rope retraction mechanism and the ratchet.

The pawl which corresponds to the ratchet is on the drum support, and is being controlled through an electric wire by the stroke-ending sensor on the hydraulic cylinder. The direction of free rotation of the ratchet is also that of the rope-retraction.

Another alternative structural form of rope-control device comprises the rope refraction mechanism, drum, overrunning clutch and electromagnetic clutch. In this case, each side of the overrunning clutch is shaft coupled with the drum and electromagnetic clutch, with the latter being controlled by the stroke-ending sensor at the hydraulic cylinder. The other end of the electromagnetic cutch is attached to the support. When the electromagnetic clutch is closed, i.e. the overrunning clutch's driven wheel is secured, the direction of the overrunning clutch's action wheel is also that of the rope-retraction.

The main parts of the generator and hydraulic system are in the chamber of the floating body. One end of a corrugated pipe is attached to the end of the piston rod of the hydraulic cylinder; the other end of the corrugated pipe is attached to the body of the hydraulic cylinder and sealed to form a cavity. This cavity is also connected to outlet and inlet tubes; the outlet tube is connected to the oil tank inside the floating body chamber via the outlet check valve. In the case of an open-type oil tank, the inlet tube is connected to the floating body cavity via the inlet check valve; in the case of a close-type oil tank, the inlet tube is connected to the oil tank via the inlet check valve. The tube's opening must be higher than the oil's surface.

Both the hydraulic system and generator are inside the floating body chamber. The hydraulic cylinder can be connected from the outside of its base to the base of the floating body via a joint through the center hole of a universal joint, or suspended bellow the top of the floating body with a rope from its top. The piston rod of the hydraulic cylinder extends from the bottom of the floating body through an opening; the bottom surface of the hydraulic cylinder is linked up with the opening via a concentric corrugated surface. A vertical seal-air pipe can be installed bellow the opening through which the piston rod of the hydraulic cylinder extends from the bottom of the floating body.

The stroke-ending sensor for the hydraulic cylinder is a magnetic induction proximity switch. Alternatively, it can be a sensor switch (sensitive to pressure and tension) at the end of the piston rod. The switch is connected to a pulling line, with one end of the pulling line attached to the bottom surface of the hydraulic cylinder. An electric connection is established when the switch is pulled. Conversely, the electric connection is broken when the switch is subject to pressure.

The stroke-ending sensor can be either the press sensor inducting to the top within the hydraulic cylinder or the press sensor inducting to the bottom at the bottom of the hydraulic cylinder.

A fairlead is fixed at the bottom of a bracket, which is fixed at the lower end of the floating body. The rope tied to the piston rod of the hydraulic cylinder passes through the fairlead and then is guided to the drum. The fairlead comprises two pairs of pulleys placed perpendicularly to each other, with the pulleys in each pair close to each other and in parallel.

This is a power-generation method by way of wave energy collection. One end of the rope is attached to the piston rod of the hydraulic cylinder, which is connected to a floating body or a swinging board. The other end of the rope, together with an additional section, is connected to a rope-control device. Thus, when the floating body rises with the wave, the rope between it and the rope-control device is in a locking state. The hydraulic cylinder is being pulled as the distance between the floating body and the anchor base increases. As the latter is being pulled, it will release high-pressure hydraulic oil to drive the hydraulic motor; the hydraulic motor will in turn drive the generation of power. When the stroke action of the hydraulic cylinder is completed, it will transmit a signal to the rope-control device to release a section of the rope, at which time the hydraulic cylinder will be rapidly reset by virtue of the reset force. When the reset is completed, the stroke-ending sensor of the hydraulic cylinder will transmit a signal to the rope-control device for the latter to cease releasing the rope. In this manner, the length of the rope between the hydraulic cylinder and rope-control device is once again locked in. As the distance between the floating body and the anchor base increases, the hydraulic cylinder is pulled again, thus repeating the above process. When the floating body drops along with the wave, the hydraulic cylinder is reset as a result of the reset force. This distance between it and the rope-control device shortens, thus causing the rope to relax, at which point the rope-control device begins to retract the rope with minimal force. When the floating body reaches the wave's trough, the rope-control device will cease retraction of the rope. The length of the rope between the floating body and the rope-control device is therefore fixed, and the process repeats itself again as the wave drops.

Double cylinder alternate acting method may be used. To be specific, the floating body is provided with two hydraulic cylinders and their respective rope-control devices. However, the signals of both stroke-ending sensors of the hydraulic cylinders are transmitted to one the micro-controller unit module. For the rope-control device with the motion directional sensor, the signals of the motion directional sensors of both rope-control devices are sent to the same micro-controller unit module;

As the floating body rises, the rope-control device of a hydraulic cylinder is being locked and the hydraulic cylinder is being pulled, whereas the rope-control device of the other hydraulic cylinder is in an unlock state—it is in a state complete reset and not working. When the floating body rises to a certain level and the stroke action of the hydraulic cylinder, which is with a rope being locked by length, is about to end, the stroke-ending sensor of the hydraulic cylinder will transmit a signal to the micro-controller unit module. At this point, the micro-controller unit module switches the working state of both rope-control devices, i.e. the rope-control device which is originally locked is unlocked to release the rope whereas the device which is originally unlocked is locked in order to lock in the length of its rope. In this way, the hydraulic cylinder which has originally completed its stroke will be reset, and the other hydraulic cylinder which is in complete reset and non-working state will begin to work as the length of its rope is being locked. The action will repeatedly switch between both hydraulic cylinders upon the transmission of the stroke-ending signal.

For a system that contains ratchets, the locking mechanisms of the two rope-control devices will always maintain a state whereby one device is locked while the other is being unlocked when the floating body drops. The rope-control device of the hydraulic cylinder in an unlock state will immediately retract the rope when the floating body drops, while the other hydraulic cylinder which is in a locked state and hence is working will be reset first, at which point its rope retraction mechanism will retract the rope with minimal force.

In the case of a system which contains a motion directional sensor instead of a ratchet, the rope-control device which is in an unlock state will immediately retract the rope when the floating body drops. When the rope-control device is in a locked state, its corresponding hydraulic cylinder will be reset first. As soon as the micro-controller unit module receives simultaneous complete reset signals from both hydraulic cylinders and the direction sensor's signal transmits a rope-retraction state, it will set the locking mechanisms for both rope-control devices in unlocking status in order for the rope-control devices to retract the rope with minimal force. As soon as the motion directional sensor releases a rope-release signal, the micro-controller unit will immediately secure the locking mechanism of one of the rope-control devices.

In this structure, the hydraulic cylinder can be replaced by a pneumatic cylinder or a linear generator or a rack and pinion driving generator mechanism.

The connection between the floating body and the hydraulic cylinder can either be hinge/solid joint or rope linking.

Several units of floating bodies and hydraulic cylinders can work simultaneously. The floating bodies are connected either by a locking ring or a candan universal joint. The hydraulic cylinders share a set of hydraulic conduit, hydraulic motor, generator, replenish pump and oil tank.

The circulation route of the hydraulic system can be formed by the hydraulic cylinder, outlet check valve, the high-pressure accumulator, hydraulic motor, the low-pressure accumulator and entry check valve. The pressure generated by the low-pressure accumulator is greater than the ambient pressure of the cylinder body. In the case of reset, the tension on the piston generated by differential pressure is greater than the rope refraction tension from the rope-control device. A relief valve is connected in parallel on both ends of the hydraulic motor; the replenish pump pumps oil from the oil tank and connects the pipeline at the low-pressure accumulator by the check valve.

In case that the rope retraction mechanism is a submerged buoy, the rope connecting the submerged buoy and the drum bypasses a spacing pulley to keep a certain distance between the submerged buoy and the drum.

If the rope-control device is fixed on the anchor base, rather than being connected via hinge joint or ropes, the rope extended from the piston rod of the hydraulic cylinder should first pass through the fairlead and then be guided to the rope-control device.

The generator may be coupled with a flywheel with great rotational inertia to increase the rotational inertia and improve generation stability.

The wire is shaped as a spiral spring with flexibility.

### DETAILED DESCRIPTION OF THE PREFERRED EMBODIMENT

Detailed descriptions on the specific embodiments of the invention are made as follows in combination with the attached figures.

It should be clarified first that, the working tension of the hydraulic cylinder is far greater than the reset tension of the hydraulic cylinder and the latter is far greater than the tension of the rope retraction of rope-control device. For example, when the acting tension of the hydraulic cylinder is 100 KN, the reset tension is only 5 KN and the rope refraction tension of the rope-control device is 500 N accordingly.

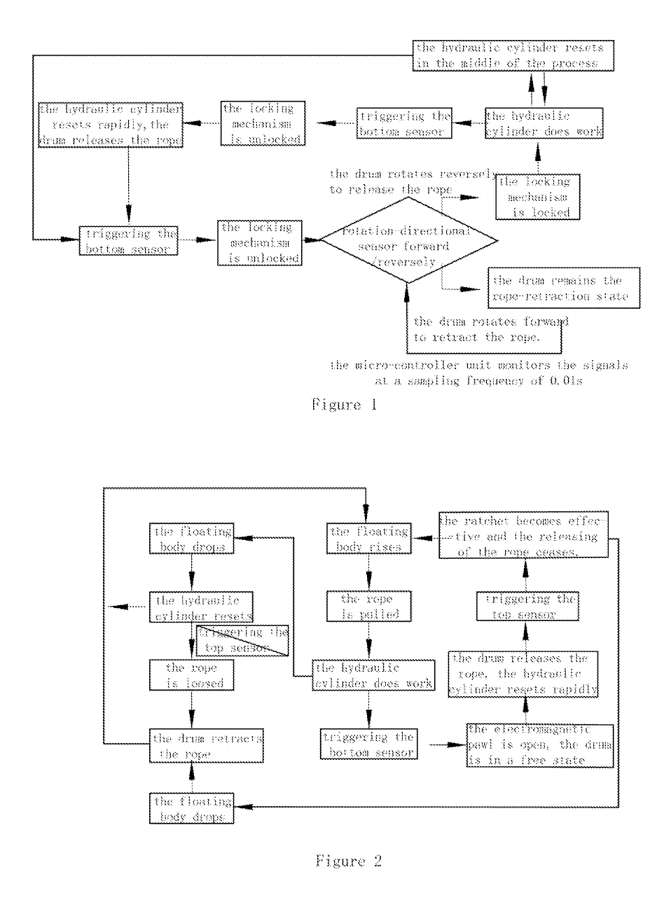

FIG. 1 and FIG. 3 are the flow charts for the rope-control process of the micro-controller unit and motion directional sensor.

When the hydraulic cylinder rises with the wave, the distance between the hydraulic cylinder and the drum becomes larger and larger. At this point in time, the rope-control device is locked and the rope cannot be released, which means the length of the rope between the hydraulic cylinder and the drum is locked, such that the hydraulic cylinder is being pulled to work.

When the piston rod of the hydraulic cylinder is pulled to the bottom, the bottom sensor is triggered and sends positive pulse signals to the micro-controller unit module. The power switch of the locking mechanism (an insulated gate bipolar transistor, or a metal oxide semiconductor field effect transistor or a solid state relay is being used as a power switch) is controlled through regulating high-voltage with weak current through the micro-controller unit. When the switch is on, the drum is in a free state as the locking mechanism is energized and unlocked. Then the hydraulic cylinder is reset rapidly via the force of the reset spring or differential pressure. The time is quite short and may be minimally 0.2 s. This process also causes the drum to release its rope.

When the piston is reset to the top, the top sensor is triggered and sends negative pulse to the micro-controller unit. At this point, the micro-controller unit should unlock the locking mechanism first (in the case that the reset is just finished, which means the locking mechanism is already under the unlock state, no action is made) to judge the rise or drop of the floating body. During such a situation the micro-controller unit is used to judge the rotation direction of the drum via the motion directional sensor. When the drum driven by the rope retraction mechanism rotates forward to retract the rope, which indicates the floating body is in a fall state, the state maintains and the micro-controller unit monitors the signals sent by the motion directional sensor at a sampling frequency of 0.01 s. Once the drum is detected to be rotating in reverse as that the drum rotates reversely to release the rope, which indicates the floating body is rising, the locking mechanism controlled by the micro-controller unit is secured immediately

At this point, the rope length between the hydraulic cylinder and the drum is locked. The hydraulic cylinder will be pulled to work as the floating body rises.

Afterwards, the top sensor will cease sending negative signals after the piston moves away from it.

If the wave conditions always maintain a state at which the hydraulic cylinder is within its own working stroke, the sensor will not be triggered and no signals will be sent out, which leads to the result whereby the micro-controller unit will make no operation and the state of the drum and locking mechanism doesn't need to be shifted. If the top sensor is triggered again, impulse will be sent out, and the micro-controller unit repeats the previous judgment process: unlocking the locking mechanism first, then making judgments of the motion state of the floating body and the decision of whether to lock or unlock. If the bottom sensor is triggered due to the wave height exceeds the stroke-length of the hydraulic cylinder, which means the piston rod is pulled to the bottom, the micro-controller unit unlocks the locking mechanism and repeats the quick reset process aforementioned at this point.

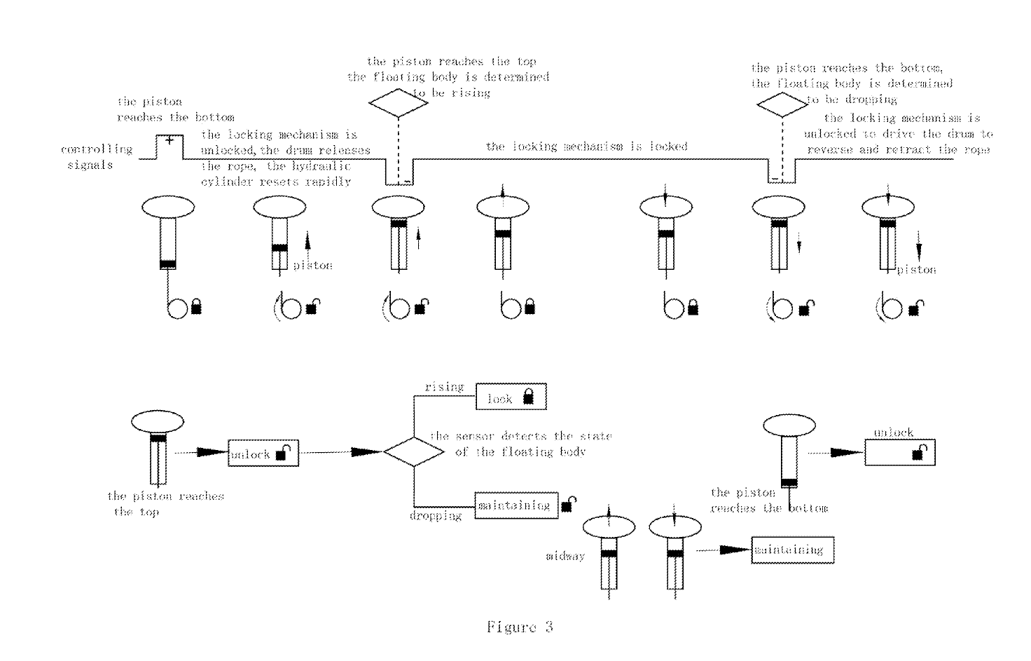

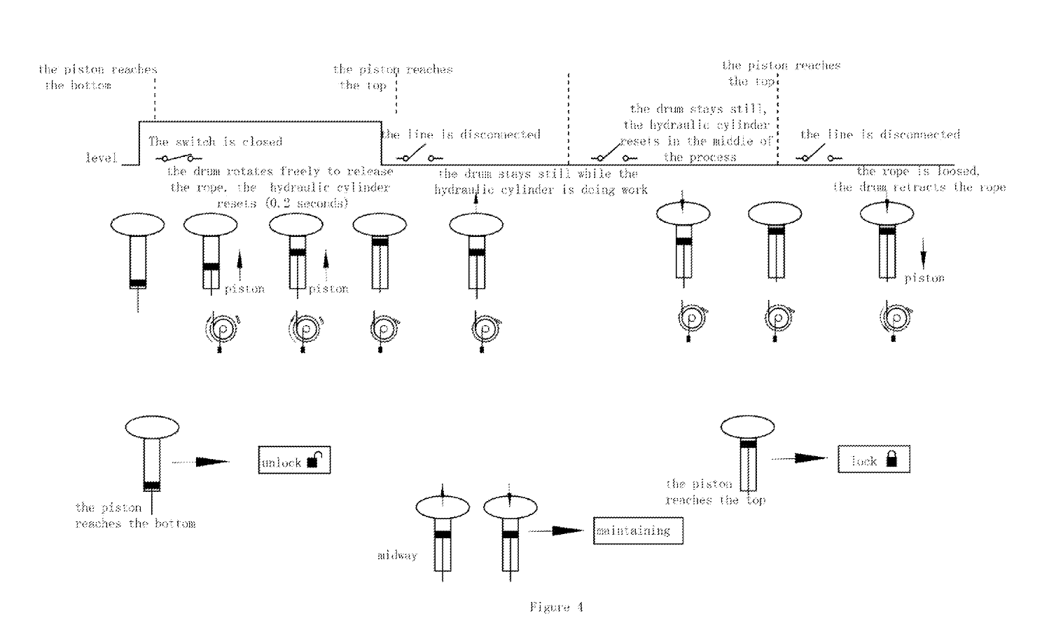

FIG. 2 and FIG. 4 refer to the rope-control method of the ratchet.

When the hydraulic cylinder rises with the increase of wave height, the distance between the hydraulic cylinder and the drum is also increased; at this point, due to restrictions by the ratchet, the rope can only be retracted instead of being released by the drum, and the tension of the hydraulic cylinder is greater than the rope retraction tension of the rope-control device; therefore, the rope will not be retracted or released, the rope length between the hydraulic cylinder and the drum will be fixed, and the hydraulic cylinder is pulled to work; when the piston rod of the hydraulic cylinder is pulled to the bottom, the bottom sensor is triggered and the switch of the wire controlling the pawl is closed and energized. Then the pawl is opened under the function of the electromagnet, the ratchet is ineffective and the drum is under a free state; because the tension generated by the reset spring or reset differential pressure is far greater than that of the rope refraction mechanism of the drum, the hydraulic cylinder resets rapidly at a considerably short time (down to 0.2 s); the process will also drive the drum to release the rope and tighten the spiral spring.

When the reset reaches the top and triggers the top sensor, the wire is disconnected. At this point, the electromagnetic pawl closes and the ratchet becomes effective. If the floating body continues rising, the rope length between the hydraulic cylinder and the drum is locked and the hydraulic cylinder will be pulled to work once again, due to the drum not being able to release the rope under the retaining function of the pawl.

If the work reaches the bottom and triggers the bottom sensor once again, the quick reset work will be repeated quickly; if the bottom sensor is not triggered and the floating body decreases midway, then the drum will not be able to perform rope refraction because it cannot be rotated reversely. The hydraulic cylinder will reset first because the tension generated by the reset spring or reset differential pressure is far greater than that of the rope retraction mechanism of the drum.

When the reset reaches the top and triggers the top sensor, the wire will be disconnected; as the wire has been disconnected previously, no effect will be made (splashed block in FIG. 2); the drum retains the effective state of ratchet. If the floating body continues dropping, as the piston rod has reached the top and cannot be retracted, and no tension to reset the hydraulic cylinder is available, the rope between the hydraulic cylinder and the drum is loosened. As the drum can only do rope retraction instead of rope releasing, the tension of the rope retraction mechanism of the drum works, the elastic potential energy of the spiral spring is released and the drum is reversed to retract the rope.

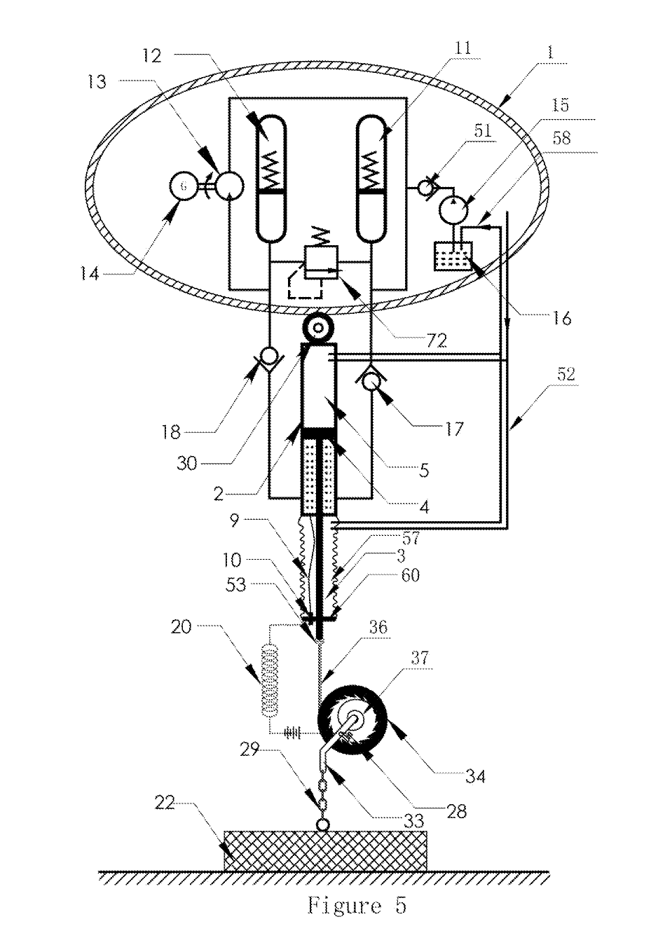

FIG. 5 is the specific structural diagram for a type of an oscillating piston wave power generation.

Feature: a low-pressure accumulator 11 is used to reset a hydraulic cylinder 2; the hydraulic cylinder is connected with a floating body via a universal joint 30; a sensor switch 10 is sensitive to pressure and tension; the rope retraction mechanism is a spiral spring 37, and a rope-control device is connected to a chain 29 of an anchor base.

The system comprises a floating body 1, an anchor base 22, a hydraulic system and a generator 14. The floating body connected to the hydraulic cylinder body; the connection between the hydraulic cylinder and the floating body is a universal joint 30.

The circulation route of the hydraulic system can be formed by the hydraulic cylinder 2, an outlet check valve 18, a high-pressure accumulator 12, a hydraulic motor 13, the low-pressure accumulator 11 and an entry check valve 17; the hydraulic motor drives the generator 14; the hydraulic cylinder is reset by differential pressure; the intensity of pressure of the rodless cavity 5 of the hydraulic cylinder is the barometric pressure; the intensity of pressure of low-pressure accumulator is about 5 times of the barometric pressures; the tension generated by the differential pressure is the product of the effective piston area multiplied by four times of the barometric pressure, which is far greater than the tension of the rope retraction mechanism.

A relief valve 72 is set between the high-pressure accumulator and the low-pressure accumulator; the relief valve is designed to guarantee the safety of the hydraulic system. If the hydraulic cylinder is being operated while the hydraulic motor 13 is not, the relief valve may be used to overflow the hydraulic oil of the high pressure part to the lower pressure part so as to lower the pressure of the high-pressure accumulator and avoid damages to the hydraulic system. In order to compensate the oil drainage loss of the hydraulic cylinder and the hydraulic motor, the replenish pump 15 is used to pump oil from an oil tank 16; while the check valve 51 is designed to prevent the backflow of the oil in the hydraulic system to the replenish pump.

Except for the hydraulic cylinder, the generator and the hydraulic system are all located in the chamber of floating body 1; a corrugated pipe, with one end attached to the bottom of the piston rod 60 of the hydraulic cylinder; the other end attached to the hydraulic cylinder body 2, (the body of the hydraulic cylinder 2) and sealed to form a cavity of the corrugated pipe 57; the cavity and the rodless cavity 5 of the hydraulic cylinder are connected with the outlet tube 58 and inlet tube 52; the outlet tube is connected to oil tank 16 within the floating body via the outlet check valve; for the open type oil tank, the inlet tube is connected with the floating body chamber by inlet check valve; and for a close type oil tank, the inlet tube is connected with the oil tank by the inlet check valve; the tube mouth is higher than the oil level to guarantee that the oil leakage of the hydraulic cylinder can return to the oil tank.

The wire 20 is shaped as a spiral spring with flexibility.

Description of the rope-control device: a webbing 36, with one end tied to the piston rod 3 of the hydraulic cylinder 2, and the other tied and wound to a drum 34; the suspension support 33 of the drum is connected to the anchor base by a chain 29; the connection between the webbing and piston rod is a rotating joint 53 to enable free rotation of the webbing. The specific gravity of the rope-control device is preferably smaller than that of water, unless the rope refraction tension of the rope-control device is big enough so that the rope-control device will not sink after the floating body drops and the hydraulic cylinder is fully reset, thus guaranteeing that the distance between the rope-control device and the hydraulic cylinder can be shortened to enable rope retraction.

The drum 34 is shaft coupled with the rope retraction mechanism and the ratchet; the rope retraction mechanism is a spiral spring 37 with one end fixed on the drum and the other on the drum support; the moment generated is in the rope retraction direction.

The pawl corresponding to the ratchet is installed on the drum support; the pawl is controlled by the stroke-ending sensor on the hydraulic cylinder via wire 20; the free rotation direction of the ratchet driving wheel is also that of the rope-retraction.

The stroke-ending sensor of the hydraulic cylinder is a sensor switch 10 which is sensitive to pressure and tension at the bottom of the piston rod 60; the switch is tied with pulling line 9 to connect the bottom surface of the hydraulic cylinder. While the switch is pulled, the wire is connected and then a pawl 28 is detached by an electromagnet. While the switch is pressed, the wire is disconnected and the pawl is closed under the function of the spring.

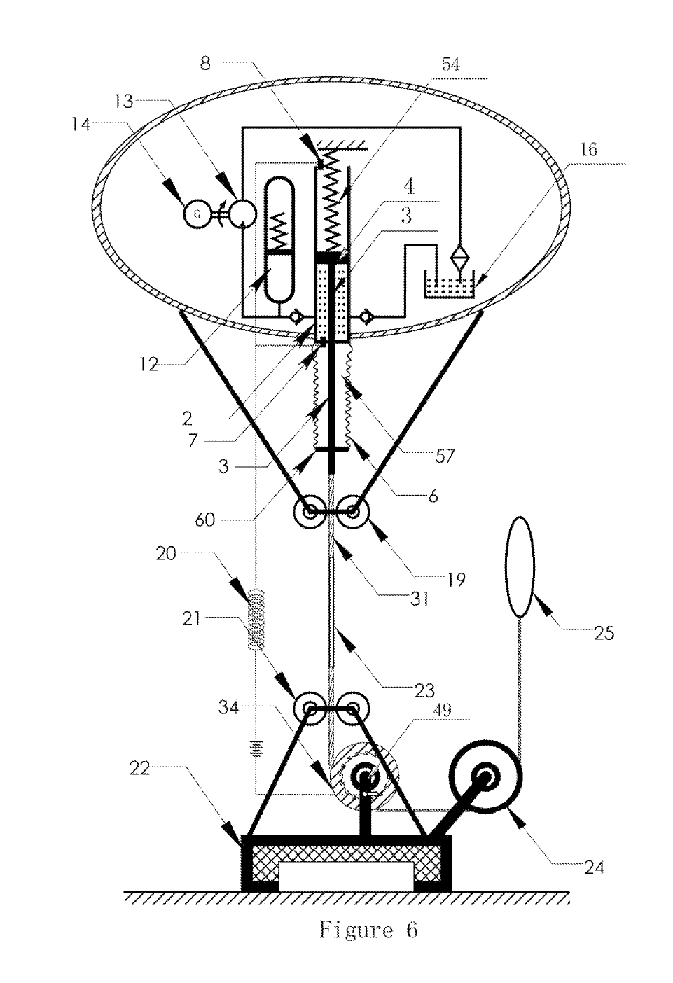

FIG. 6 is another embodiment of a different type of oscillating piston wave generation.

Features: The spring 54 is applied to reset the hydraulic cylinder; the hydraulic cylinder is connected to the floating body by a solid joint; sensors are set at the bottom and top of the hydraulic cylinder; a fairlead 19 is used; the rope retraction mechanism realizes the rope-retraction via a submerged buoy 25; the drum 34 and anchor base 22 are in fixed connection.

The system involves a floating body 1, an anchor base 22, a hydraulic system and a generator 14; the hydraulic cylinder and floating body are in solid connection. The generator and the hydraulic system are all in the floating body chamber; a corrugated pipe 6, with one end attached to the bottom of the piston rod 60 of the hydraulic cylinder, the other end attached to the hydraulic cylinder body 2, sealed to form a cavity of the corrugated pipe 57.

The circulation route of the hydraulic system comprises the hydraulic cylinder 2, an outlet check valve, a high-pressure accumulator 12, a hydraulic motor 13, an oil tank 16, an entry check valve.

A rope 31, with one end tied to the piston rod 3 of the hydraulic cylinder 2, and the other end tied and wound to drum 34 of the rope-control device, passes through a fairlead 19 in the midway; the fairlead is two pairs of parallel pulleys 44 that are mutually perpendicular (FIG. 16).

The drum 34 is shaft coupled with the rope refraction mechanism and the ratchet; the rope retraction mechanism is a thin rope with one end fixed and wound on the drum and the other tied to a submerged buoy 25; the moment generated is in the rope 31 refraction direction; the thin rope connecting the submerged buoy and the drum bypasses a spacing fixed pulley 24 to keep a certain distance between the submerged buoy and the drum; this preventive measure is taken to avoid mutual winding of the rope under the submerged buoy with rope 31. A fixed support 49 of the drum is in fixed connection with the anchor base; the middle section free from any winding of the rope is replaced by a pull rod 23 to enhance the rigidity.

The pawl corresponding to the ratchet is on the drum support; the pawl is controlled by the stroke-ending sensor on the hydraulic cylinder via wire 20; the free rotation direction of the driving wheel of the ratchet in solid joint with the drum is in the direction of rope 31 retraction.

The stroke-ending sensors of the hydraulic cylinder are a sensor 8 on the top surface and a sensor 7 on the bottom surface in the cavity of the hydraulic cylinder.

As the angle of the rope 31 is subject to change, a fairlead 21 is added on the anchor base to guarantee that the rope can be smoothly wound onto the drum 34 on anchor base 22.

The wire 20 is shaped as a spiral spring with flexibility.

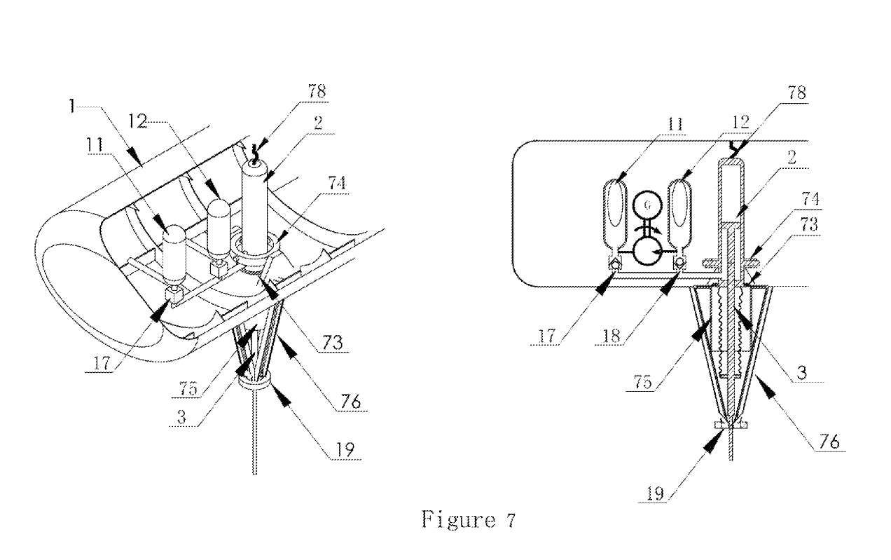

FIG. 7 is the perspective view and section view of the oscillating piston wave power generation system (upper part).

The lower end on the side of hydraulic cylinder body 2 is connected by a joint with the bottom surface of the floating body 1 by a universal joint with a hole in the centre 74; the piston rod 3 of the hydraulic cylinder extends from an opening on the bottom surface of floating body 1; the hydraulic cylinder body is connected with the opening by a concentric corrugated surface 73; a high-pressure accumulator 12, a low-pressure accumulator 11, an outlet check valve 18, an entry check valve 17 and other hydraulic system parts as well as the generator are all within the floating body; a vertical seal-air pipe 75 is installed around the opening on the bottom surface of the floating body.

The function of seal-air pipe 75 is to seal part of the air; as the bottom surface of the floating body always faces downwards, the air will not escape, which prevents the entry of the sea water into the floating body chamber. The universal joint with a hole in the centre 74 is a round ring, with a countershaft respectively from inside and outside; the two countershafts are mutually perpendicular; the hydraulic cylinder body is in the center and may rotate around the countershaft inside the universal joint; the countershaft on the outer side of the universal joint is installed and rotates on the support on the bottom of the floating body; the function of the universal joint is to adjust the angle of hydraulic cylinder 2, which can avoid the horizontal force of the piston rod 3 and piston on the cylinder body and further reduce abrasion and leakage. In this figure, there's only one port on the hydraulic cylinder for oil inlet and outlet.

The piston rod 3 connected to the rope passes through the fairlead 19 under the floating body. The fairlead is fixed on the bottom of the bracket 76 under the floating body. To avoid a situation whereby the downward pull force by the rope-control device is too small when the floating body drops and the hydraulic cylinder body 2 is too heavy, which would further result in tilting on the universal joint, a short rope 78 is tied on the top of the hydraulic cylinder body and connected to the top of the floating body so as to catch the hydraulic cylinder in case of tilting. In case that there's no universal joint on the lower end of the hydraulic cylinder, short rope 78 may also work as a joint to align the hydraulic cylinder to the direction of the tension.

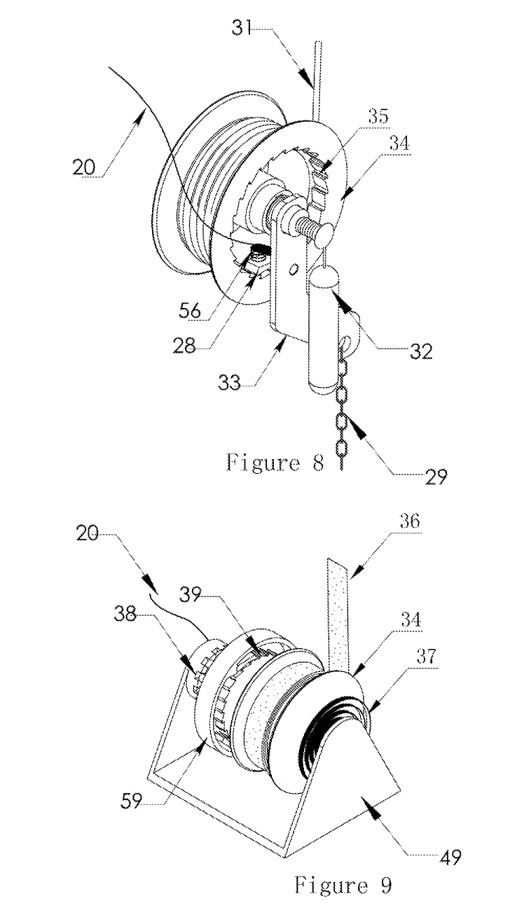

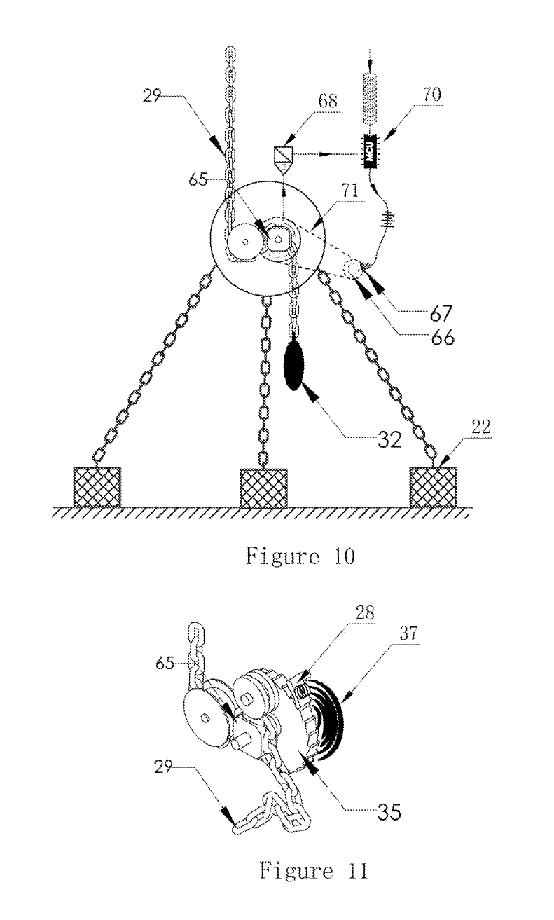

FIG. 8, FIG. 9, FIG. 10 and Figure show another four types of rope-control device structures.

Structure of FIG. 8: The drum 34 is wound by rope 31; the suspension support 33 of the drum is tied with a chain 29; a thin rope is on the shaft of the drum 34 and tied with the counterweight 32; the torque generated by counterweight enables drum to retract the rope 31. Internal ratchet 35 is embedded on the drum, and the corresponding electronic control pawl is installed on the suspension support 33; the attachment and detachment of pawl is activated by electromagnet 56 which is controlled by wire 20. If the force of the electromagnet is not sufficient, electronic control hydraulic may be used for amplification.

Structure of FIG. 9: A webbing 36 is wound on a drum 34; the rope retraction mechanism is a spiral spring 37 with one end fixed on the drum and the other on a drum support; the moment generated is in the direction of the webbing refraction; the drum is coupled with the driving wheel of a overrunning clutch 39; the driven wheel 59 of the overrunning clutch is coupled with an electromagnetic clutch 3; the other end of the electromagnetic clutch is fixed on a fixed support 49. Wire 20 can control the engagement and disengagement of an electromagnetic clutch 38.

Structure of FIG. 10: A chain 29 is wound on a chain wheel 65; wounding is not made repeatedly and covers only less than one circle; similar to the chain block, there's a counterweight 32 tied to the bottom of the chain to provide tension for chain refraction. The chain wheel 65 and brake disc 66 are driven by a chain 71; the brake pad 67 is controlled by a micro-controller unit module 70; the micro-controller unit module 70 receives signals from the stroke-ending sensor on the hydraulic cylinder and monitors the rotary direction of chain wheel 65 via the signals of motion directional sensor 68. The rope-control device is connected to three anchor bases 22 by three ropes to form three-point fix.

Structure of FIG. 11: A chain wheel 65 is coupled with a ratchet 35 and spiral spring 37; a pawl 28 is controlled by a wire; the lower part of chain 29 is free.

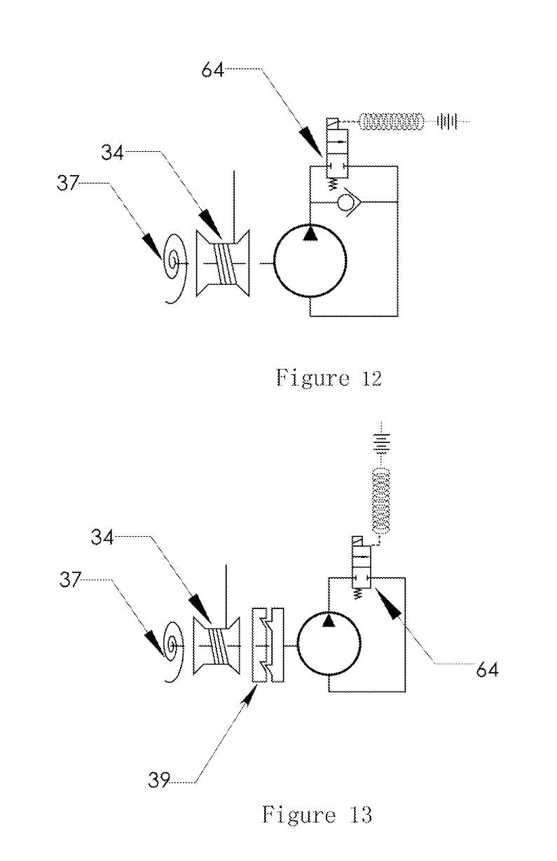

FIG. 12 refers to the structural diagram of the check valve controlled hydraulic rope-control device.

The rope retraction mechanism is a spiral spring 37. A switch valve 64 and a check valve's parallel connection forms a branch which is connected to the positive displacement pump by way of series connection to form a closed-loop hydraulic conduit. That constitutes the formation of the locking mechanism. The drum 34 is shaft coupling with the positive displacement pump and the spiral spring; generally, the switching valve is closed; as restricted by the check valve, the positive displacement pump can only be rotated in one direction; in other words, it can only be rotated along the rope retraction direction under the function of the spiral spring; unless the switching valve 64 can be open by the stroke-ending sensor of the hydraulic cylinder after the end state of the stroke is detected by the sensor. At this point, the positive displacement pump may be rotated forward or reversely, which means that releasing of the rope can be performed under the tension of the rope from the hydraulic cylinder.

FIG. 13: Structural diagram of the locking mechanism with positive displacement pump and rope-control device with overrunning clutch.

A drum 34 is coupled with a spiral spring 37, a overrunning clutch 39, a positive displacement pump; the positive displacement pump is in parallel with the switching valve 64 in a closed loop of hydraulic pipeline to form the locking mechanism; generally, the switching valve 64 is closed, in other words, the locking mechanism is locked; at this point, due to the unidirectional transmission feature of the overrunning clutch, the drum may rotate only in one direction, which is the direction of rope refraction; unless after the ending state of the stroke is detected by the sensor of the hydraulic cylinder, the switching valve 64 can be opened by the stroke-ending sensor; at this point, the positive displacement pump may be rotated forward or reversely; the overrunning clutch becomes ineffective, which means the releasing of the rope can be performed under the tension of the rope from the hydraulic cylinder.

FIG. 14 refers to the structural diagram and the operating diagram of a double cylinder system with a single floating body.

The floating body is simultaneously equipped with two hydraulic cylinders and their respective rope-control devices; the rope-control device is of ratchet type; however, the signals of stroke-ending sensors of both the hydraulic cylinders are transmitted to the same micro-controller unit module 70; for the rope-control device with motion direction sensor, signals of the motion directional sensors of both the rope-control devices are sent to the same micro-controller unit module.

As the floating body rises, the rope-control device of a hydraulic cylinder is being locked and the hydraulic cylinder is being pulled, whereas the rope-control device of the other hydraulic cylinder is in an unlock state—it is in a state complete reset and not working. When the floating body rises to a certain level, the stroke of the hydraulic cylinder whose rope is locked is about to end, the stroke-ending sensor of the hydraulic cylinder will send a signal to the micro-controller unit module. At this point, the micro-controller unit module switches the working state of both rope-control devices, i.e. the rope-control device which is originally locked is unlocked to release the rope whereas the device which is originally unlocked is locked in order to lock in the length of its rope. In this way, the hydraulic cylinder which has originally completed its stroke will be reset, and the other hydraulic cylinder which is in complete reset and non-working state will begin to work as the length of its rope is being locked. The action will repeatedly switch between both hydraulic cylinders upon the transmission of the stroke-ending signal.

The locking mechanisms of the two rope-control devices will always maintain a state whereby one device is locked while the other is being unlocked when the floating body drops. The rope-control device of the hydraulic cylinder in an unlock state will immediately retract the rope when the floating body drops, while the other hydraulic cylinder which is in a locked state and hence is working will be reset first, at which point its rope refraction mechanism will retract the rope with minimal force.

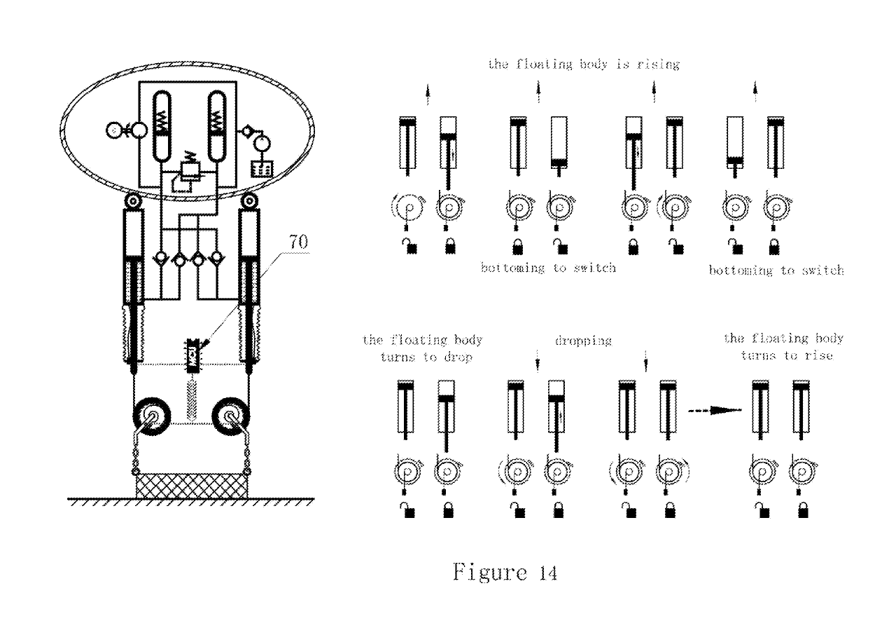

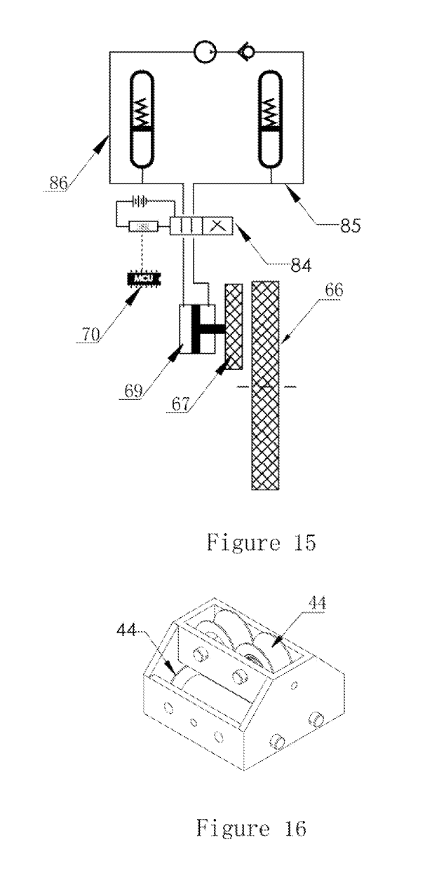

FIG. 15 refers to a schematic of the control of brake pad by the micro-controller unit via the solenoid directional valve.

This figure is the schematic of a micro-controller unit controlled locking mechanism and brake pad, which involves solenoid directional valve 84, a high-pressure oil circuit 85, a low-pressure oil circuit 86, a tank of the brake system 69, a brake pad 67; the micro-controller unit module 70 controls the on-off of the solenoid directional valve by a solid-state relay. Under both modes, the solenoid directional valve controls the switching of connection between the rodless cavity, rod cavity, high-pressure oil circuit and low-pressure oil circuit. In this Figure, the rodless cavity of the tank of the brake system is connected with a low-pressure oil circuit whereas the rod cavity is connected with a high-pressure oil circuit; the oil cylinder piston moves leftwards and drives the brake pad away from brake disc 66 to unlock the locking mechanism. When the micro-controller unit module enables the rodless cavity of the tank of the brake system being connected with the high-pressure oil circuit and the rod cavity being connected with the low-pressure oil circuit via controlling the reversing of the solenoid valve, the piston will move rightwards under the differential pressure to enable the engagement between the brake disc and the brake pad to lock the brake disc by friction. At this point, the locking mechanism is under locked status, similar to the ABS function of the automobile.

FIG. 16 refers to the structural schematic of a fairlead.

Two pairs of pulleys 44 with parallel shafts are installed mutually perpendicular onto the support.

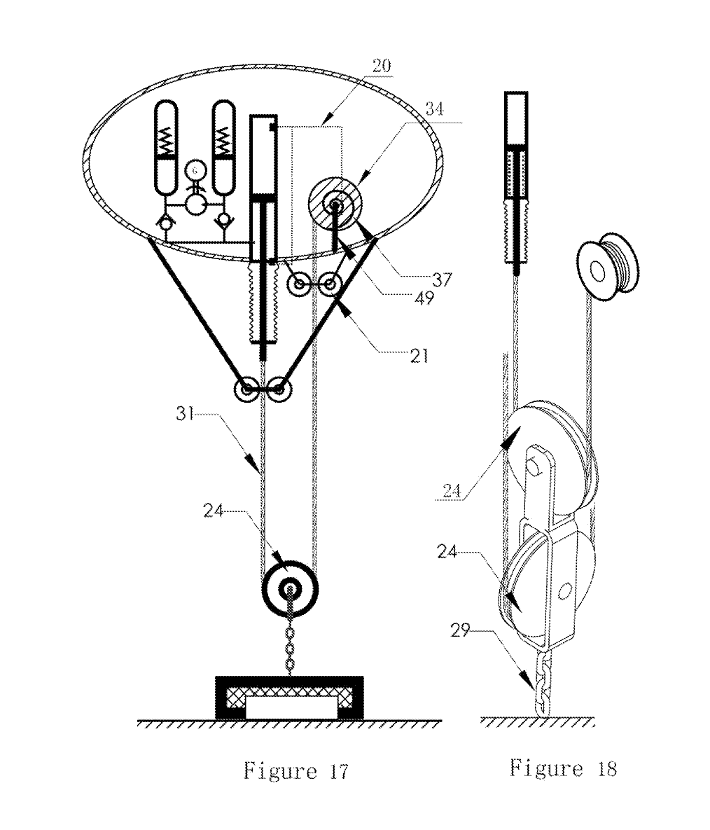

FIG. 17 refers to the diagram of a structure in which the rope-control device is fixed to the floating body via a fixed support 49.

The rope 31 tied on the hydraulic cylinder piston rod goes through the fixed pulley 24 on the anchor base, and then goes upwards to connect the rope-control device.

To enable the rope to be smoothly wound on the drum 34 of the rope-control device, there is a fairlead 21 installed under the floating body for the rope-control device. Wire 20 on the hydraulic cylinder can be just connected to the rope-control device within the floating body instead of being connected underwater. As the floating body on the sea surface is swinging and the counterweight and submerged buoy cannot make rope refraction smoothly, only a spiral spring 37 can be selected to provide the rope retraction force.

In the event that a single floating body is equipped with two sets of hydraulic cylinders and rope-control devices, with all the rope-control devices installed within the floating body, the problem of mutual winding of the rope should be prevented. Solution: The fixed pulleys 24 of the two sets are set mutually perpendicular; and the two fixed pulleys are installed onto one support; the support is connected to the anchor base by rope 29, as shown in FIG. 18. Four fairleads arranged as four vertexes of a square are required under the floating body. The four fairleads may share one common bracket.

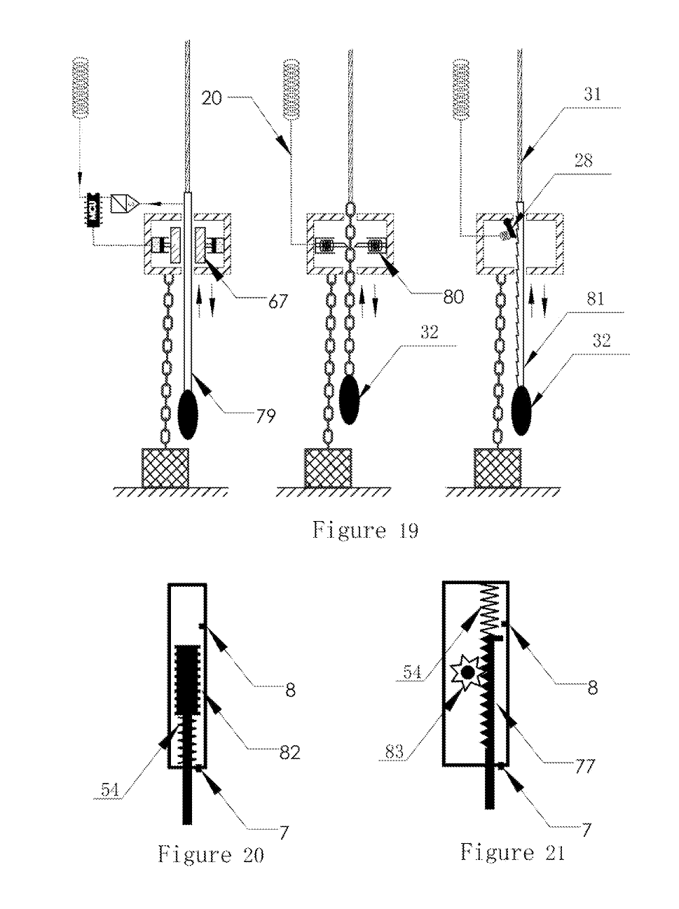

FIG. 19 refers to the diagram of the rope-control device of three types of linear-motion locking mechanism.

The three types are respectively a brake pad 67 and a counterweight 32, an electric bolt lock 80 with a counterweight and a ratchet bar 31 and a counterweight. The brake pad is a long bar with high friction coefficient that locks via the mutual static friction with the brake pad; the electric bolt lock functions via the blocking of a lock bolt and a chain; the ratchet bar is a unidirectional transmission mechanism.

FIG. 20 refers to the structural diagram of the linear generator and stroke-ending sensors 7, 8; mover 82 gets the reset force by the reset spring 54 below.

FIG. 21 refers to the structural diagram of a rack 77 and pinion 83 and stroke-ending sensors 7, 8; the rack 77 relies on the tension spring in the upper part to get the reset force.

1-24. (canceled)

25. An implement mechanism of a rope-control device of a wave-energy collect and power generation system, wherein the implement mechanism comprises an electrically controlled locking mechanism and a rope retraction mechanism;
one component of the locking mechanism can be fixed on the support of the implement mechanism of the rope-control device and the other is a moving part; If it is linear motion, the moving component moves together with the rope from the external of the implement mechanism for they are connected directly; If it is rotary motion, the moving component of the locking mechanism is connected with the rope previously mentioned via the linear-rotary motion conversion mechanism;
the linear-rotary motion conversion mechanism is formed by wrapping a rope around the drum, or by passing a chain around the chain wheel or a rack and pinion transmission mechanism, whose rotary component is connected with other mechanism by a shaft coupling in order to transmit motion;
the rope retraction mechanism can be a motor/spring/gas spring/counterweight/submerged buoy, which is connected with the moving component of the locking mechanism, generating an opposite force against the pulling rope force generated via the external of the implement mechanism; If it is linear motion, the moving component of the locking mechanism can be connected directly with the extension spring or the compression spring or the gas spring or the counterweight or the linear motor or the rope linked with the submerged buoy, bypassing the fixed pulley which is fixed on the support of the rope-control device; if the moving component of the locking mechanism is in the form of rotational movement, it can be shaft-coupled with the rotary motor or the spiral spring; or the moving component of the locking mechanism can be connected via the linear-rotary motion conversion mechanism with the linear motor or the extension spring or the compression spring or the gas spring or a string which is connected with the counterweight or the submerged buoy; the other end of the extension spring or the expression spring or the gas spring or the spiral spring is fixed on the support of the rope-control device.

26. The implement mechanism of the rope-control device of the wave-energy collect and power generation system according to claim 25, wherein the locking mechanism is a pair of components which rub against or occlude each other; The two component parts of the locking mechanism are separated or joined by a control which is implemented through regulating high-voltage with weak current through the micro-controller unit, or using a stroke-ending sensor to exercise switching control over electric circuits of the power source to realize the connection or disconnection of electric current which causes actuation or separation of the electromagnet or the control over the rotation of the motor; and the amplification can be chosen to be done by way of hydraulic or gear transmission in order to drive separation or joining of the pair of component parts in the locking mechanism ; Alternatively, one can exercise control over the electromagnetic valve in the pneumatic or hydraulic conduits at the pressure source—through pressure control on the piston which is connected to the moving component part of the locking mechanism, generating action to separate or join the pair of component parts;
the locking mechanism may also be a positive displacement pump and an electromagnetic switching valve which are connected in series and form a closed loop conduit;
the locking mechanism can take the form of an electromagnetic clutch, or a brake disc and a brake pad, or a brake bar and a brake pad, or an electric bolt lock and a chain.

27. The implement mechanism of the rope-control device of the wave-energy collect and power generation system according to claim 25, wherein
the locking mechanism comprises the solenoid directional valve, high-pressure oil circuit, low-pressure oil circuit, tank of the braking system and brake disk and brake pad; The solenoid directional valve controls the switching of connection between the rodless cavity/rod cavity and high-pressure oil circuit/low-pressure oil circuit, and the piston rod of the braking system tank is connected with the brake pad;

28. The implement mechanism of the rope-control device of the wave-energy collect and power generation system according to claim 25, wherein the rope-control device also includes an overrunning clutch; the driving wheel of the overrunning clutch is shaft coupled with the rope retraction mechanism or connected with the rope retraction mechanism via the linear-rotary conversion mechanism; the driving wheel of the overrunning clutch is connected with the rope from the external of the implement mechanism via the linear-rotary conversion mechanism; and the driven wheel of the overrunning clutch is connected with the support via the locking mechanism.

29. The implement mechanism of the rope-control device of the wave-energy collect and power generation system according to claim 25, wherein the rope from the external of the implement mechanism is wound on the drum; The drum's locking mechanism consists of a brake disc which is shaft coupled with the drum and a brake pad;
Alternatively, it can be an electromagnetic clutch with one end shaft coupled with the drum and the other end fixed to the drum support; Either of the above can indirectly control the drum through variable gear transmission or chain transmission;
The drum is shaft coupled with the rope retraction mechanism which is a PWM motor, or a spiral spring with one end shaft coupled with the drum and the other end attached to the drum support, such that the torque produced is in the direction of rope refraction; Alternatively, the rope retraction mechanism can be designed as: one end of a rope is attached to and coiled around another drum shaft coupled to the drum, with the other end attached to a counterweight or submerged buoy such that the torque produced is in the direction of rope retraction;
The drum and rope can also be respectively replaced by a chain wheel and chain, with the rope-retraction mechanism replaced by a chain attached to a counterweight; the other end of the extension spring or the expression spring or the gas spring or the spiral spring is fixed on the support of the rope-control device.

30. The implement mechanism of the rope-control device of the wave-energy collect and power generation system according to claim 25, wherein the formation of the locking mechanism is as follows: The switch valve and the check valve's parallel connection forms a branch which is connected to the positive displacement pump via a series connection to complete a closed-loop hydraulic conduit;

31. A rope-control device of a wave-energy collect and power generation system, wherein the rope-control device comprises an electronic control section, an implement mechanism and a signal transmission device; The electronic control section comprises a micro-controller unit module, stroke-ending sensors of a hydraulic cylinder or a linear generator or a rack and the auxiliary power source; the micro-controller unit module controls the locking mechanism via the signals received from the stroke-ending sensors;
The implement mechanism comprises an electrically controlled locking mechanism and a rope retraction mechanism;
One component of the locking mechanism can be fixed on the support of the rope-control device and the other is a moving part; If it is linear motion, the moving component moves together with the rope from the external of the implement mechanism for they are connected directly; If it is rotary motion, the moving component of the locking mechanism is connected with the rope previously mentioned via the linear-rotary motion conversion mechanism;
The linear-rotary motion conversion mechanism is formed by wrapping a rope around the drum, or by passing a chain around the chain wheel or a rack and pinion transmission mechanism, whose rotary component is connected with other mechanism by a shaft coupling in order to transmit motion;
The rope retraction mechanism can be a motor/a spring/a gas spring/a counterweight/a submerged buoy, which is connected with the moving component of the locking mechanism, generating an opposite force against the force generated via the pulling rope from the external of the implement mechanism; if it is linear motion, the moving component of the locking mechanism can be connected directly with the extension spring or the compression spring or the gas spring or the counterweight or the linear motor or the rope linked with the submerged buoy, bypassing the fixed pulley which is fixed on the support of the rope-control device; if the moving component of the locking mechanism is in the form of rotational movement, it can be shaft-coupled with the rotary motor or the spiral spring of the rope retraction mechanism; or the moving component of the locking mechanism can be connected via the linear-rotary motion conversion mechanism with the linear motor or the extension spring or the compression spring or the gas spring or a string which is connected with the counterweight or the submerged buoy; the other end of the extension spring or the expression spring or the gas spring or the spiral spring is fixed on the support of the rope-control device;
The signal transmission device can be either a signal transduction wire or fiber or a sonic wave transmission device; the implement mechanism is controlled by the electronic control section via the signal transmission device.

32. The rope-control device of the wave-energy collect and power generation system according to claim 31, wherein: the stroke-ending sensor for the hydraulic cylinder is a magnetic induction proximity switch; alternatively, it can be a sensor switch which is sensitive to pressure and tension at the end of the piston rod; the switch is connected to a pulling line, with one end of the pulling line attached to the bottom surface of the hydraulic cylinder; an electric connection is established when the switch is pulled; conversely, the electric connection is broken when the switch is subject to pressure;
The stroke-ending sensors can also be the press sensor inducting to the top within the hydraulic cylinder and the press sensor inducting to the bottom at the bottom of the hydraulic cylinder.

33. A implement mechanism of a rope-control device of a wave-energy collect and power generation system, wherein the unidirectional transmission mechanism and the rope retraction mechanism are included; the unidirectional transmission mechanism is a ratchet or ratchet bar;
The implement mechanism of the ratchet bar mode is as follows: the top of the ratchet bar is connected with a rope from the external of the implement mechanism, and the bottom end is connected with a counterweight; the corresponding pawl of the ratchet bar is fixed on the rack of the implement mechanism; and controlled via the wire; the ratchet bar passes through the top and bottom gap of the rack of the implement mechanism;
The implement mechanism of the ratchet mode is like this: a webbing, with one end attached to the drum, wraps around the drum which shaft coupling with the rope retraction mechanism and the ratchet; for the rope retraction mechanism: one end of the spiral spring is fixed on the drum and the other end is fixed on the support of the drum, and the torque produced is in the direction of rope retraction; the corresponding pawl of the ratchet is fixed on the support and controlled via the wire; the principle of the pawl controlling is: When the electromagnet is energized, the pawl is detached by the suction; when the power is off, the pawl is closed via the action of the spring.

34. The implement mechanism of the rope-control device of the wave-energy collect and power generation system according to claim 25, wherein the support of the implement mechanism is fixed on the anchor base, or connected by a rope with the anchor base; the support of the implement mechanism can also be fixed to the floating body; one end of the rope from the implement mechanism bypasses a fixed pulley of the anchor base and is tied to the piston rod of the hydraulic cylinder.
